(19) United States
(12) Patent Application Publication
(10) Pub. No.: US 2012/0092563 A1
(43) Pub. Date: Apr. 19, 2012

(54) REMOTE CONTROLLER FOR DISPLAY APPARATUS AND CONTROL METHOD THEREOF

(75) Inventors: Bo-kyun KWON, Suwon-si (KR); Jin-wook CHOI, Suwon-si (KR)

(73) Assignee: SAMSUNG ELECTRONICS CO., LTD., Suwon-si (KR)

(21) Appl. No.: 13/156,000

(22) Filed: Jun. 8, 2011

(30) Foreign Application Priority Data
Oct. 14, 2010 (KR) 10-2010-0100178

(51) Int. Cl. H04N 5/44

(52) U.S. Cl. 348/734; 348/E05.096

(57) ABSTRACT

A remote controller is provided for a display apparatus and a control method thereof. The remote controller for a display apparatus includes a communication unit which communicates with a display apparatus and a remote terminal, a user input unit which receives a user's command, and a controller which performs a control operation to transmit a user's first command for manipulating the display apparatus to the display apparatus, to be remotely connected to the remote terminal and transmit to the display apparatus a terminal image received from the remote terminal and transmit to the remote terminal a user's second command for a manipulation of the remote terminal. With this configuration, users may control a remote terminal.

### CROSS-REFERENCE TO RELATED APPLICATION

This application claims priority from Korean Patent Application No. 10-2010-0100178, filed on Oct. 14, 2010 in the Korean Intellectual Property Office, the disclosure of which is incorporated herein by reference.

### BACKGROUND

1. Field

Apparatuses and methods consistent with the exemplary embodiments relate to a remote controller for a display apparatus and a control method thereof, and more particularly, to a remote controller for a display apparatus which communicates with a remote terminal, and a control method thereof.

2. Description of the Related Art

A related art display apparatus such as a television (TV) is manipulated by an exclusive remote controller (hereinafter, also referred to as “a remote controller for a display apparatus”). The related art remote controller has been developed to provide extended functions such as self-display and communication with other devices as well as manipulation of a display apparatus.

Technologies for remotely controlling a terminal such as a personal computer (PC) have continued to be developed. In particular, there is a rising demand for controlling a terminal (hereinafter, also referred to as “a remote terminal”) at a remote place.

In line with the development of the functions of the remote controller for the display apparatus, hardware of the remote controller has become large, and a requirement for a reduced power consumption is also present.

### SUMMARY

Accordingly, one or more exemplary embodiments provide a remote controller for a display apparatus and a control method thereof which enables a user to control a remote terminal.

Another exemplary embodiment provides a remote controller for a display apparatus and a control method thereof.

The foregoing and/or other aspects may be achieved by providing a remote controller for a display apparatus including a communication unit which communicates with a display apparatus and a remote terminal, a user input unit which receives a user's command, and a controller which performs a control operation to transmit a user's first command for manipulating the display apparatus to the display apparatus, to be remotely connected to the remote terminal and to transmit to the display apparatus a terminal image received from the remote terminal, and to transmit to the remote terminal a user's second command for a manipulation of the remote terminal.

The controller may include a frame buffer which stores therein data of the terminal image received from the remote terminal, and an encoder which compresses data stored in the frame buffer.

The user input unit may include at least one of a keyboard input unit including a plurality of keys and a touch input unit detecting a user's touch to receive the user's command.

The remote controller may further include a power switch to transit on/off power; and a power unit which terminates power from being supplied to the controller if the power switch is transited off.

The controller may store in the storage unit the user's first command before a booting of the display apparatus is completed and transmit the user's first command stored in the storage unit to the display apparatus after the booting of the display apparatus is completed if the power switch is transited on to supply power.

The controller may transmit a turn-on signal to the display apparatus and transmit to the display apparatus the user's first command after the display apparatus notifies a completion of the booting if the power switch is transited on to supply power.

The display apparatus may include a TV which receives a broadcasting signal from at least one of a plurality of channels and display an image, and the user's first command may include a command to select one of the plurality of channels.

Accordingly to another exemplary embodiment, a control method of a remote controller for a display apparatus is provided. The control method includes receiving a user's first command to manipulate a display apparatus, transmitting the user's first command to the display apparatus, remotely connecting to a remote terminal, receiving a terminal image from the remote terminal; transmitting the terminal image to the display apparatus; receiving a user's second command to manipulate the remote terminal, and transmitting the user's second command to the remote terminal.

The transmitting the terminal image may include storing data of the terminal image received from the remote terminal in a frame buffer, and compressing the data stored in the frame buffer.

The control method according to the exemplary embodiment may further include cutting off power supplied to the remote controller if a power switch is transited off.

The control method may further include initiating supply of power to the remote controller if the power switch is transited on; storing the user's first command in a storage unit before a booting of the display apparatus is completed; and transmitting the user's first command stored in the storage unit to the display apparatus after the booting of the display apparatus is completed.

The control method may further include transmitting a turn-on signal to the display apparatus if the power switch is transited on; and receiving a notice of the completion of the booting from the display apparatus, and the transmitting the stored user's first command may include transmitting the stored user's first command to the display apparatus after the booting completion is notified.

The display apparatus of the exemplary embodiment may include a TV which receives a broadcasting signal from at least one of a plurality of channels and displays an image, and the user's first command may include a command to select one of the plurality of channels.

### BRIEF DESCRIPTION OF THE DRAWINGS

The above and/or other aspects will become apparent from the following description of the exemplary embodiments, taken in conjunction with the accompanying drawings, in which:

FIG. 1 illustrates a display apparatus, a remote controller and a remote terminal according to an exemplary embodiment;

FIG. 2 is a block diagram of the remote controller according to the exemplary embodiment in FIG. 1;

FIG. 3 illustrates a configuration of a user input unit of the remote controller according to the exemplary embodiment in FIG. 1;

FIG. 4 illustrates a configuration of a controller of the remote controller according to the exemplary embodiment in FIG. 2;

FIG. 5 is a flowchart of an exemplary control process of the display apparatus, the remote controller and the remote terminal according to the exemplary embodiment in FIGS. 1; and

FIG. 6 is a flowchart of another exemplary control process of the display apparatus, the remote controller and the remote terminal according to the exemplary embodiment in FIG. 1.

### DETAILED DESCRIPTION OF THE EXEMPLARY EMBODIMENTS

Below, exemplary embodiments will be described in detail with reference to accompanying drawings so as to be realized by a person having an ordinary level of skill in the art. The exemplary embodiments may be embodied in various forms without being limited to the exemplary embodiments set forth herein. Descriptions of well-known parts may be omitted for clarity, and like reference numerals refer to like elements throughout.

The term “turn” may be used interchangeably with respect to the “transit” of a switching device or controller between an “on” state and an “off” state. However, the use of the term “turn” is not intended to refer to a change in the physical orientation, direction or position of a structure, but rather to a change in the operating state.

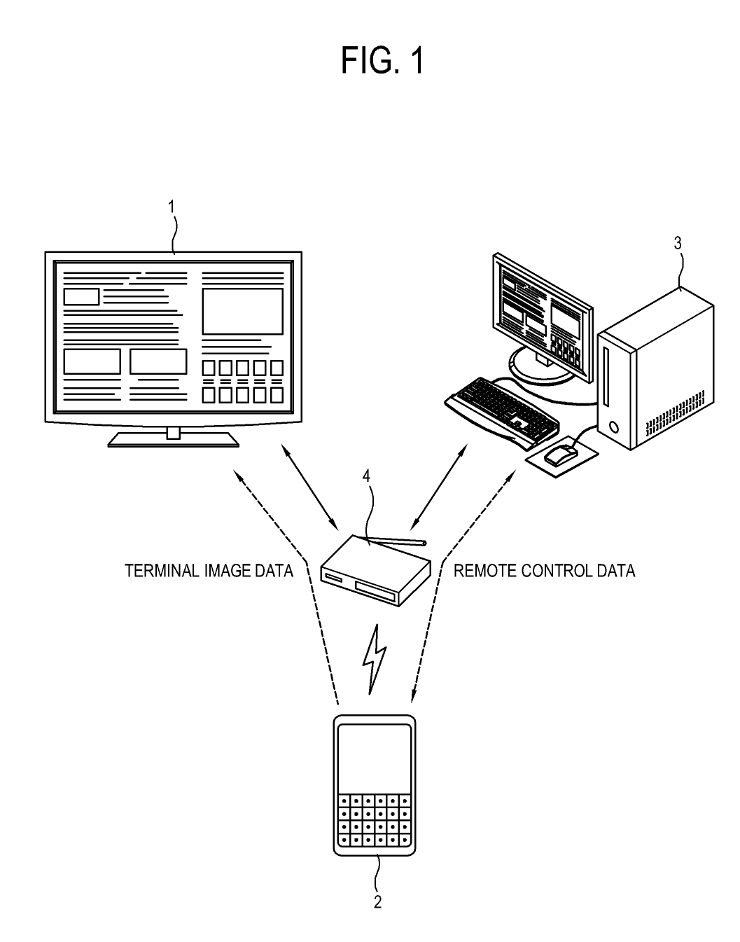

FIG. 1 illustrates a display apparatus, a remote controller and a remote terminal according to an exemplary embodiment. A display apparatus 1 may be configured as a TV or the like, but is not limited thereto, and other equivalent structures as would be understood by those in the art may be substituted therefor. The display apparatus 1 operates by a user's command which is received from a remote controller 2. A remote terminal 3 may be configured as a PC. The remote terminal 3 is remotely controlled by a user's command received from the remote controller 2. An access point (AP) 4 may be provided between the display apparatus 1 and the remote controller 2, and between the remote terminal 3 and the remote controller 2. The display apparatus 1 and the remote controller 2, and the remote terminal 3 and the remote controller 2 communicate with each other through the AP 4. The communication performed between the display apparatus 1 and the AP 4, and between the remote terminal 3 and the AP 4 includes, without limitation, wireline communication and wireless communication. The communication performed between the remote controller 2 and the AP 4 includes wireless communication.

The remote controller 2 receives screen data of the remote terminal 3 from the remote terminal 3 and transmits such data to the display apparatus 1. The display apparatus 1 displays an image based on the screen data of the remote terminal 3 received through the remote controller 2. A user inputs a user's second command to remotely control the remote terminal 3 by using the remote controller 2 while viewing an image displayed in the display apparatus 1. The remote controller 2 transmits the input user's second command to the remote terminal 3, and the remote terminal 3 operates by the transmitted user's second command. As shown in FIG. 1, data for a remote control (hereinafter, to be also called “remote control data”) is transmitted and received between the remote terminal 3 and the remote controller 2, and image data including the screen data of the remote terminal 3 (hereinafter, to be also called “terminal image data”) is transmitted from the remote controller 2 to the display apparatus 1.

The display apparatus 1 may include a communication unit, an image processor, a display unit, a storage unit and a controller which are not shown. The communication unit of the display apparatus 1 communicates with the remote controller 2 through the AP 4 to receive a user's first command and the terminal image data. According to another exemplary embodiment, the display apparatus 1 may further include a remote control signal receiver which is separately provided from the communication unit communicating with the AP 4 and receives a remote control signal form the remote controller 2 corresponding to the user's first command. The remote control signal includes an infrared signal, a Bluetooth signal or the like. Other equivalent communication protocols as would be understood by those skilled in the art may be applied.

The display apparatus 1 may further include a receiver and further receive an image signal including an image content. The image signal may include an audio content and/or a data content as well as the image content. The image signal includes a broadcasting signal transmitted by a broadcasting station and a signal input by an image device (e.g., predetermined). The receiver may selectively receive a broadcasting signal from one of a plurality of channels. The broadcasting signal includes an air wave broadcasting signal, a cable broadcasting signal, a satellite broadcasting signal and other broadcasting signals as would be understood by those skilled in the art. The type of the broadcasting signal includes digital broadcasting and analog broadcasting.

The receiver may communicate with an image device transmitting an image signal corresponding to the property of the input image signal. Such communication includes wireline communication and wireless communication, and analog communication and digital communication. The type of communication includes all types of communication that may be used for transmitting an image content. The type of the image device supplying the image signal to the receiver includes a digital versatile disc (DVD) player, a blue-ray disc (BD) player, a PC, a mobile phone, a smart phone and other TVs but not limited thereto as understood by those skilled in the art. The receiver may receive an image signal from a server (e.g., predetermined) through a network, or receive an image signal from a portable storage medium such as a universal serial bus (USB) device.

The image processor processes the terminal image data and the image contents for display. The image processing performed by the image processor includes demultiplexing, decoding, scaling, picture quality adjustment and picture quality improvement. The image processor may process an image on a user interface (UI) menu for a user interface. The image processor may overlap an image obtained from an image content and at least a part of a UI menu in a single screen, or arrange the foregoing side by side.

The display unit displays thereon an image processed by the image processor. The method of displaying an image by the display unit may include a display method known to those skilled in the art. The display method may be provided by using liquid crystal display (LCD), organic light emitting diode (OLED), plasma display panel (PDP), projection, cathode ray tube (CRT), or others known in the art.

The storage unit stores therein data for an operation of the display apparatus 1.

The controller controls overall operations of the display apparatus 1. The controller may control the communication unit to receive the terminal image data from the remote controller 2. The controller may further control the receiver to receive an image signal from a desired channel according to a user's first command received from the remote controller 2. The controller may control the image processor to process the received terminal image data and image contents.

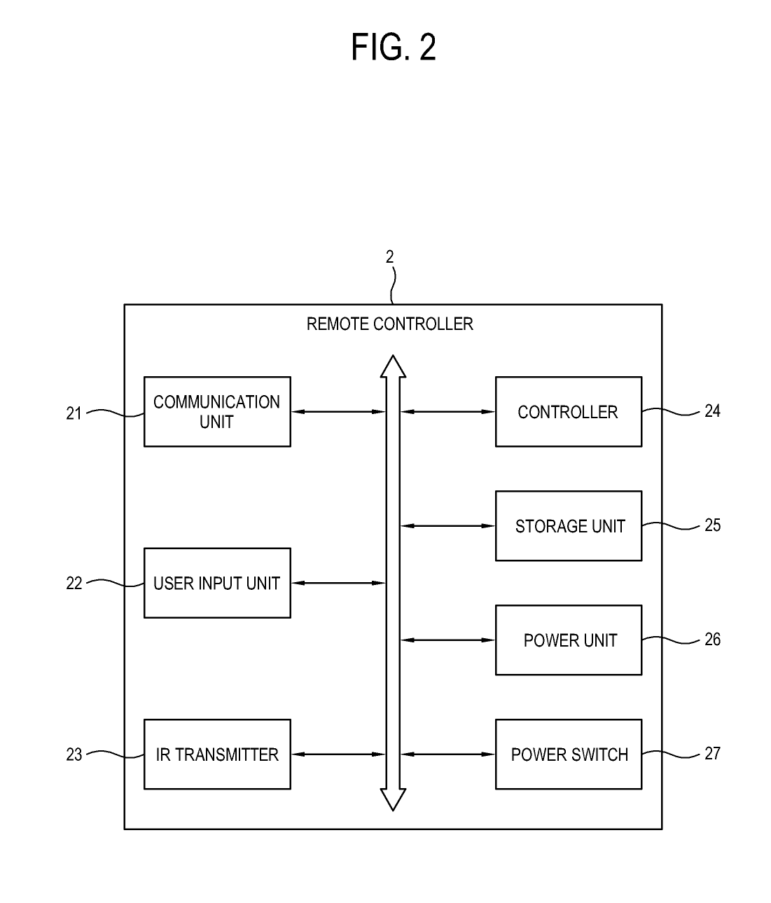

FIG. 2 is a block diagram of the remote controller 2 according to the exemplary embodiment. As shown therein, the remote controller 2 may include a communication unit 21, a user input unit 22 and a controller 24. The communication unit 21 communicates with the display apparatus 1 and the remote terminal 3 through the AP 4. The communication performed between the communication unit 21 and the AP 4 includes a wireless communication scheme such as wireless local area network (LAN), Wi-Fi or the like.

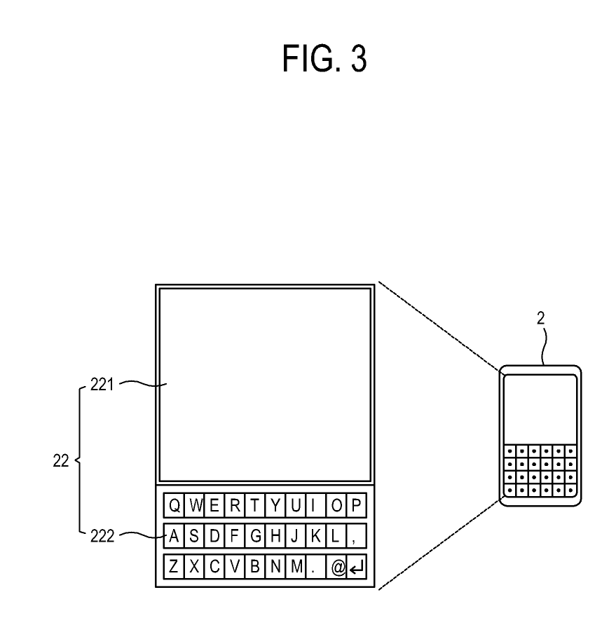

The user input unit 22 receives a user's input. FIG. 3 illustrates a configuration of the user input unit 22 according to the exemplary embodiment. As shown therein, the user input unit 22 may include a touch input unit 221 and a keyboard input unit 222. The touch input unit 221 receives a user's input by detecting a user's contact on a panel by his/her finger. The keyboard input unit 222 includes a plurality of keys and receives a user's input including a character or a number.

The controller 24 performs a control operation for a manipulation of the display apparatus 1. More specifically, the controller 24 transmits a user's command for a manipulation of the display apparatus 1 input through the user input unit 22 (hereinafter, to be also called “user's first command”) to the display apparatus 1 through the communication unit 21. The display apparatus 1 performs a corresponding operation according to the user's first command received from the remote controller 2. The user's first command includes a transit-on/off of power, change of channel, volume up/down or the like. According to another exemplary embodiment, the remote controller 2 may further include an infrared (IR) transmitter 23 which transmits an IR signal to the display apparatus 1 corresponding to the user's first command.

The controller 24 performs a remote control operation of the remote terminal 3. More specifically, the controller 24 receives a terminal image from the remote terminal 3, and transmits the received terminal image to the display apparatus 1. The display apparatus 1 displays the terminal image received from the remote controller 2. Then, a user may view a screen of the remote terminal 3 through the display apparatus 1.

The controller 24 transmits a user's command for controlling the remote terminal 3 input through the user input unit 22 (hereinafter, to be also called “user's second command”) to the remote terminal 3 through the communication unit 21. The remote terminal 3 performs a corresponding operation according to the user's second command received from the remote controller 2. The user's second command includes information of operations which may be performed by the remote terminal 3 such as a TV. For example, a user may move a cursor of the remote terminal 3 or click any menu by using the touch input unit 221 of the user input unit 22 or select characters by using the keyboard input unit 222 of the user input unit 22. That is, the user input unit 22 may act as a mouse and a keyboard of the remote terminal 3.

As above, according to the exemplary embodiment, a user may control the remote terminal 3 such as a PC, use a program installed in the remote terminal 3 or use and read data stored in the remote terminal 3 by using the display apparatus 1 and the remote controller 2.

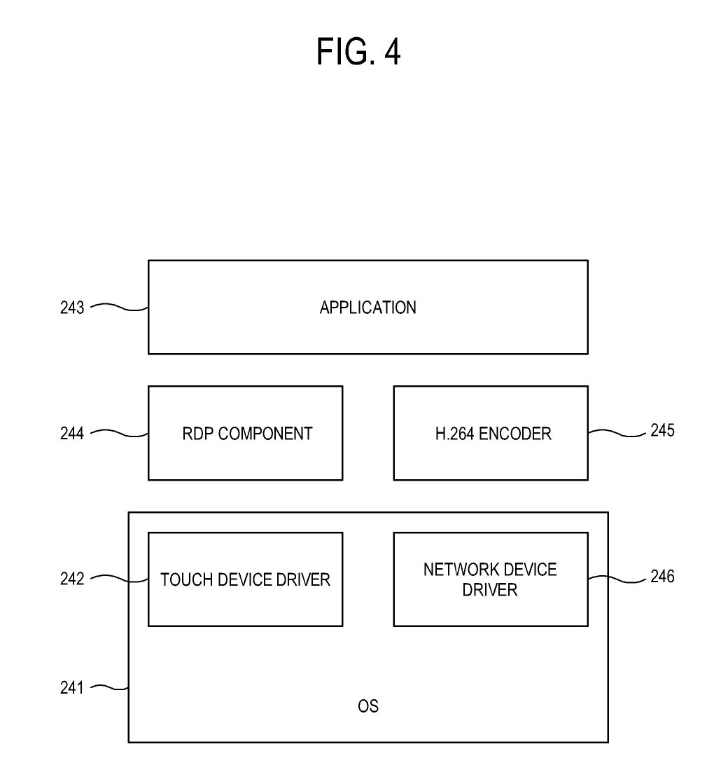

The controller 24 may include a non-volatile memory (e.g., computer-readable medium) to store therein an execution code of a computer program (software) corresponding to the control operation, a volatile memory to load at least a part of the execution code stored in the non-volatile memory, and a microprocessor to execute the execution code loaded to the volatile memory. FIG. 4 is a block diagram of the software (SW) configuration of the controller 24 according to an exemplary embodiment.

The SW configuration of the controller 24 includes an operating system (OS) 241, a touch device driver 242, a network device driver 246, a remote desktop protocol (RDP) component 244, an H.264 encoder 245 and an application 243. The OS performs an overall management and control function of the remote controller 2. The touch device driver 242 controls the touch input unit 221, and the network device driver 246 controls the communication unit 21. The RDP component 244 processes RDP data for a control of the remote terminal 3. The H.264 encoder 245 compresses the RDP data of a terminal image received from the remote terminal 3 to be transmitted to the display apparatus 1. The controller 24 may store in a virtual frame buffer the RDP data of the terminal image received from the remote terminal 3, and the H.264 encoder 245 may compress the RDP data stored in the frame buffer. The remote controller 2 may further include the storage unit 25 as the frame buffer. The storage unit 25 may be configured as, e.g., an electrically erasable programmable read-only memory (EEPROM), a flash memory, and a hard disk drive (HDD), but is not limited thereto. As the remote controller 2 processes the RDP data of the terminal image, the display apparatus 2 does not need to have an additional configuration to process the RDP data.

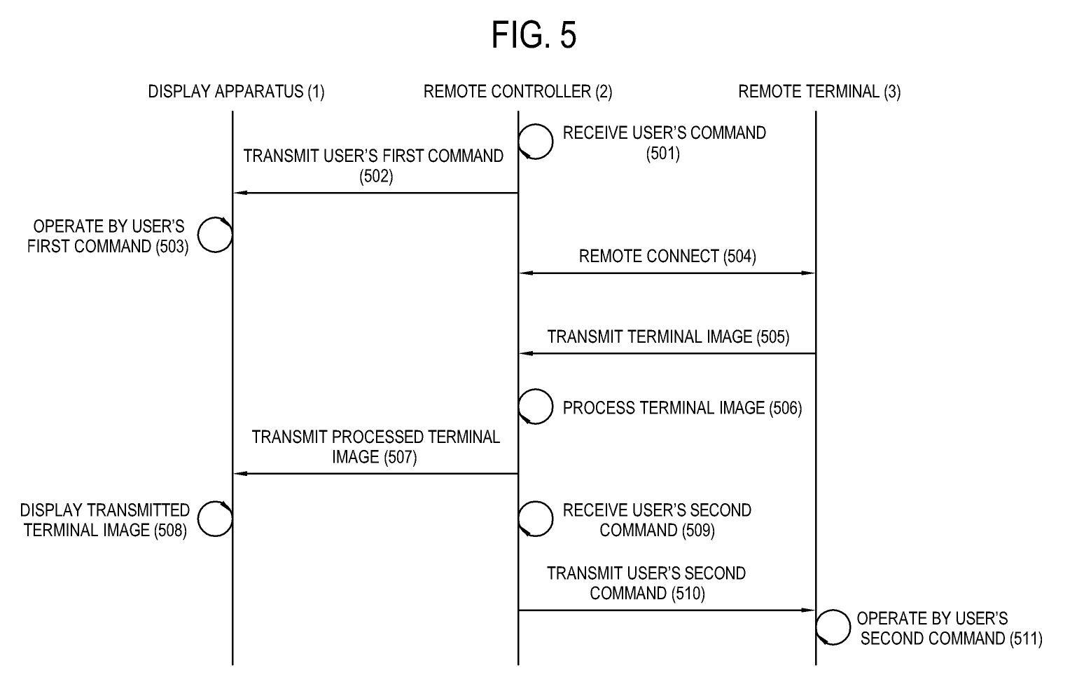

FIG. 5 is a flowchart of a control process of the display apparatus 1, the remote controller 2 and the remote terminal 3 according to an exemplary embodiment. At operation 501, the remote controller 2 receives an input of the user's first command to manipulate the display apparatus 1. At operation 502, the remote controller 2 transmits the input user's first command to the display apparatus 1. At operation 503, the display apparatus 1 performs the corresponding operation according to the user's first command upon receiving the user's first command from the remote controller 2.

At operation 504, the remote controller 2 and the remote terminal 3 initiate the mutual connection for the remote control. Initiating the remote connection between the remote controller 2 and the remote terminal 3 may be performed by a user's command. The user's command for initiating the remote connection may be input from either the remote controller 2 or the remote terminal 3. If the remote connection between the remote controller 2 and the remote terminal 3 is performed, the remote terminal 3 transmits the terminal image to the remote controller 2, the terminal image corresponding to the currently-displayed screen of the remote terminal 3, at operation 505. At operation 506, the remote controller 2 processes the terminal image, by frame-buffering, compressing, or the like, received from the remote terminal 3. At operation 507, the remote controller 2 transmits the processed terminal image to the display apparatus 1. At operation 508, the display apparatus 1 displays the terminal image transmitted by the remote controller 2.

At operation 509, the remote controller 2 receives the user's second command to control the remote terminal 3. At operation 510, the remote controller 2 transmits the user's second command to the remote terminal 3. At operation 511, the remote terminal 3 performs the corresponding operation according to the user's second command received from the remote controller 2.

Hereinafter, the display apparatus 1 and the remote controller 2 according to another exemplary embodiment will be described. Returning to FIG. 2, the remote controller 2 further includes a power unit 26 to supply power to hardware such as the controller 24, and a power switch 27 to transit on/off the remote controller 2. If a user transits off the remote controller 2 by using the power switch 27, the power unit 26 ceases supply of power to the hardware such as the controller 24. According to the present exemplary embodiment, power supplied to most of hardware of the remote controller 2 may be cut off except for a monitoring circuit (which may be included in the power unit 26) of the power switch 27 to turn on the remote controller 2. Then, power consumption of the remote controller 2 when not in use may be minimized.

According to another exemplary embodiment, the remote controller 2 may minimize power consumption in a standby mode other than its turn-off (e.g., transit to an off position). For example, if a user does not use the remote controller 2 for a time (e.g., predetermined), the remote controller 2 may determine to enter into a standby mode and cease supply of power supplied to each element.

If the remote controller 2 is transited on, the controller 24 may transit on the display apparatus 1, and may transmit the stored user's command to the display apparatus 1 once the display apparatus 1 is transited on and achieves normal operating conditions. Then, the remote controller 2 may minimize its power consumption and a user does not need to wait to input a command until the display apparatus 2 becomes normal.

According to another exemplary embodiment, if the remote controller 2 is transited off in the standby mode, it may monitor whether a user is using the user input unit 22, and may enter into the normal mode and resume power supply if it is determined that he/she is using the user input unit 22.

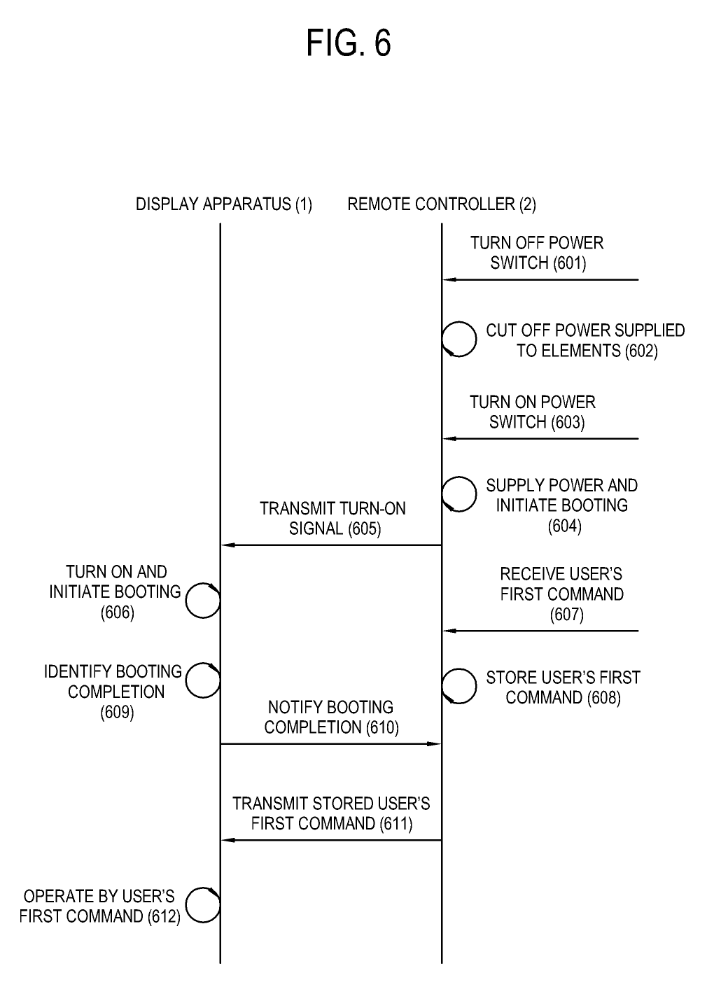

FIG. 6 is a flowchart of a control process of the display apparatus 1 and the remote controller 2 according to an exemplary embodiment. The display apparatus 1 and the remote controller 2 are may be transited on and operate normally. First, at operation 601, the remote controller 2 receives a user's manipulation to transit off the remote controller 2 through the power switch 27. At operation 602, the remote controller 2 ceases power supply to elements such as the controller 24. The remote controller 2 may transmit a turn-off signal to the display apparatus 1 when the user's command to transit off the display apparatus 1 is received. The display apparatus 1 ceases power supply to each of the elements and is transited off upon receiving the turn-off signal from the remote controller 2.

At operation 603, the remote controller 2 receives a user's manipulation to transit on the display apparatus 1 through the power switch 27. At operation 604, the remote controller 2 supplies power to each element and initiates booting. At operation 605, the remote controller 2 transmits the turn-on signal to the display apparatus 1. The turn-on signal may be transmitted by the IR transmitter 23 in FIG. 2. The turn-on signal may be transmitted before or after the completion of booting the remote controller 2. If the remote controller 2 is transited on, the IR transmitter 23 receives power initially to promptly operate under normal conditions. That is, before a kernel of the OS 241 is loaded, the IR transmitter 23 is first normalized in a boot loader terminal, and then a kernel of the OS 241 and device drivers are loaded to normalize other necessary devices and conduct the loading.

According to another exemplary embodiment, the turn-on signal may be transmitted from the remote controller 2 to the display apparatus 1 by the controller 24 of the remote controller 2. Before the booting of the remote controller 2 is completed, the controller 24 may not operate under normal conditions. Thus, the controller 24 may further include an additional element such as a microcomputer (not shown; a smaller control processor than a CPU) to transmit the turn-on signal.

At operation 606, the display apparatus 1 supplies power to each element and initiates booting upon receiving the turn-on signal from the remote controller 2. Before the booting of the display apparatus 1 is completed, at operation 607, the remote controller 2 receives the user's first command to manipulate the display apparatus 1. At operation 608, the remote controller 2 stores the input user's first command. To be prepared for the case when the user's command is input immediately after the remote controller 2 is transited on, the kernel of the OS 241 first normalizes the user input unit 21 of the remote controller 2 and is able to receive the user's command promptly.

At operation 609, the display apparatus 1 identifies whether the booting is completed. If the booting is completed, the display apparatus 1 notifies the remote controller 2 of the completion of the booting at operation 610. The remote controller 2 may be booted more rapidly than the display apparatus 1 as the remote controller 2 may have a fewer number of drivers to be loaded than the display apparatus 1 does. In this case, the remote controller 2 is ready to receive a notice of booting completion from the display apparatus 1. According to another exemplary embodiment, to be prepared for the case when the booting of the display apparatus 1 is completed earlier, the kernel of the OS 241 first normalizes the communication unit 21 of the remote controller 2 to receive the notification of the booting completion from the display apparatus 1.

At operation 611, the remote controller 2 transmits the stored user's first command to the display apparatus 1 if the display apparatus 1 notifies the booting completion. The user's first command may be transmitted by either the IR transmitter 23 or the communication unit 21. At operation 612, the display apparatus 1 performs the corresponding operation according to the user's first command upon receiving the user's first command from the remote controller 2. According to the exemplary embodiment, power consumption of the remote controller 2 is minimized.

As described above, a remote controller for a display apparatus and a control method thereof according to an exemplary embodiment enables a user to control a remote terminal.

Also, a remote controller for a display apparatus and a control method thereof according to an exemplary embodiment may consume less power.

As explained above, a computer-readable medium may be provided to implement the foregoing operations as instructions.

Although a few exemplary embodiments have been shown and described, it will be appreciated by those skilled in the art that changes may be made in these exemplary embodiments without departing from the principles and spirit of the inventive concept, the range of which is defined in the appended claims and their equivalents.

What is claimed is:

1. A remote controller comprising:
a communication unit configured to communicate with a display apparatus and a remote terminal;
a user input unit configured to receive an input; and
a controller which performs a control operation to transmit a first command for manipulating the display apparatus to the display apparatus, the controller remotely connected to the remote terminal and transmitting to the display apparatus an image received from the remote terminal, and transmitting to the remote terminal a second command for manipulating the remote terminal.

2. The remote controller according to claim 1, wherein the controller comprises a storage unit configured to store data of the terminal image received from the remote terminal; and
an encoder configured to compress data stored in the storage unit.

3. The remote controller according to claim 1, wherein the user input unit comprises at least one of a keyboard input unit comprising a plurality of keys and a touch input unit detecting a user's touch to receive the input.

4. The remote controller according to claim 1, further comprising a power switch to transit on/off power; and
a power unit which ceases power supply to the controller if the power switch is transited off.

5. The remote controller according to claim 4, wherein the controller stores in a storage unit the user's first command before a booting of the display apparatus is completed, and transmits the user's first command stored in the storage unit to the display apparatus after the booting of the display apparatus is completed if the power switch is transited on to supply power.

6. The remote controller according to claim 5, wherein the controller transmits a turn-on signal to the display apparatus and transmits to the display apparatus the first command after the display apparatus communicates a completion of the booting if the power switch is transited on to supply power.

7. The remote controller according to claim 1, wherein the display apparatus comprises a TV which receives a broadcasting signal from at least one of a plurality of channels and displays an image, and the first command comprises a command to select one of the plurality of channels.

8. A method of controlling a remote controller for a display apparatus, the method comprising:
receiving a first command to manipulate a display apparatus;
transmitting the first command to the display apparatus;
remotely connecting to a remote terminal;
receiving a terminal image from the remote terminal;
transmitting the terminal image to the display apparatus;
receiving a second command to manipulate the remote terminal; and
transmitting the second command to the remote terminal.

9. The method according to claim 8, wherein the transmitting the terminal image comprises storing data of the terminal image received from the remote terminal in a storage unit; and
compressing the data stored in the storage unit.

10. The method according to claim 8, further comprising ceasing power supply to a remote controller if a power switch is transited off.

11. The method according to claim 10, further comprising initiating supply of power to the remote controller if the power switch is transited on;
storing the user's first command before a booting of the display apparatus is completed; and
transmitting the first command stored in the storage unit to the display apparatus after the booting of the display apparatus is completed.

12. The method according to claim 11, further comprising:
transmitting a turn-on signal to the display apparatus if the power switch is transited on; and
receiving a notice of the completion of the booting from the display apparatus,
wherein the transmitting the stored first command comprises transmitting the stored first command to the display apparatus after the booting completion is notified.

13. The method according to claim 8, wherein the display apparatus comprises a TV which receives a broadcasting signal from at least one of a plurality of channels and displays an image, and the first command comprises a command to select one of the plurality of channels.

14. A display apparatus comprising:
a receiver configured to receive an image signal;
an image processor configured to process the image signal for display;
a display unit configured to display a first image based on the image signal processed by the image processor;
a communication unit configured to communicate with a remote controller; and
a controller which performs a control operation to display the first image on the display unit according to a user's command from the remote controller, and to receive an image data from the remote controller and display on the display unit a second image based on the image data.

15. The display apparatus according to claim 14, wherein the controller decompresses the image data to display the second image.

16. The display apparatus according to claim 14, wherein when the display apparatus supplies power to each element and initiates booting upon receiving a turn-on signal from the remote controller, the controller notifies the remote controller of the completion of the booting.

17. A method of controlling a display apparatus, the method comprising:
receiving a user's command from a remote controller;
receiving an image signal according to the user's command;
displaying a first image based on the image signal on a display unit;
receiving an image data from the remote controller; and
display on the display unit a second image based on the image data.

18. The method according to claim 17, further comprising decompressing the image data to display the second image.

19. The method according to claim 17, further comprising, when the display apparatus supplies power to each element and initiates booting upon receiving a turn-on signal from the remote controller, notifying the remote controller of the completion of the booting.
